(19) United States
(12) Patent Application Publication
(10) Pub. No.: US 2011/0067289 A1
(43) Pub. Date: Mar. 24, 2011

(54) Duck Dog

(76) Inventor: William Roger Lane, Tulsa, OK (US)

(21) Appl. No.: 12/804,378

(22) Filed: Sep. 23, 2009

(51) Int. Cl. A01M 31/06

(52) U.S. Cl. 43/3

(57) ABSTRACT

A remote controlled duck decoy to retrieve downed waterfowl off a body of water. It is remote steered and driven from a hand-held transmitting unit and pushes the downed waterfowl to the bank utilizing two extendable pushrods that are manually pulled out prior to use. These are retractable so they will not break or bend when they are stored or transported. There is also a stud on the front of the decoy that allows it to deploy decoys or to pull the multiple decoy back to shore with a deploying jerk cord assembly. It is externally prop driven with a moss and weed guard for keeping debris away from the prop.

### FEDERALLY SPONSORED RESEARCH

Not Applicable

### SEQUENCE LISTING OR PROGRAM

Not Applicable

### BACKGROUND

1. Field

This application relates to waterfowl hunters who all own some form of device to retrieve downed waterfowl.

2. Prior Art

Everyone that duck-hunts own some form of retrieving waterfowl whether it is by dog, boat, or by wading in the lakes, ponds or rivers. A number of drawbacks are associated with using hunting dogs as it is expensive and time consuming to train a dog to retrieve downed waterfowl. The expenses of having a hunting dog include the training of the dog, the clean up and hassle of dog pins, vet bills and food for the dog. Also, a dog is more like to damage the skin or tissues of the downed waterfowl.

Due to various degrees in temperature during duck hunting season it is not always safe to wade into freezing lakes, ponds or rivers. Using a boat is another costly method to retrieve downed waterfowl but is not always an option.

U.S. Pat. No. 4,545,315 does not look like a waterfowl for attracting ducks it is a device with a basket that scoops up the downed waterfowl. The present invention actually has the appearance of a duck and therefore attracts the waterfowl not scaring them away and pushes the downed waterfowl to the bank.

U.S. Pat. No. 5,367,813 is similar as it looks like a decoy however it is for attracting decoys but not retrieving downed waterfowl or deploying decoys.

Furthermore, the following design patents illustrate the state of the art in duck decoys:
U.S. Pat. No. D. 268,863 discloses a duck decoy with stabilizing elements.
U.S. Pat. No. D. 268,047 discloses a duck decoy with stabilizing sponsors and keel.
U.S. Pat. No. D. 270,656 discloses a duck decoy stabilizer for use in stormy weather.
U.S. Pat No. D. 268,863 discloses a duck decoy stabilizer for use in stormy weather.
U.S. Pat No. D. 268,862 discloses a combined duck decoy and stabilizers.
U.S. Pat. No. 5,367,813 is similar as it looks like a decoy however it is for attracting decoys but not retrieving downed waterfowl or deploying decoys.

U.S. Pat. No. 5,377,439 is a remote controlled decoy resembling a game bird body and has a remote controlled anchoring system the anchoring system can also be used for towing the prey as well as an apparatus for grasping the prey. The beak on this unit opens to grasp the downed waterfowl which is problematic as it causes the unit to be front heavy while trying to bring the downed waterfowl to the bank which makes the propulsion of the motor ineffective. The problem with internal propulsion once fouled it is harder to clean out. This unit also has a slave device for towing decoys.

The Duck Decoy invention differs by pushing the downed waterfowl to the bank instead of grasping or grappling the prey which makes the motor more effective and efficient. The present invention also has an external prop with a mesh covering so that it is protected from moss and debris.

U.S. Pat. No. 5,636,466 is only for attracting waterfowl with leg and wing movement it does not deploy or retrieve downed waterfowl.

U.S. Pat. No. 6,389,732 is a radio controlled fishing apparatus used for fishing. It is only similar in the respect that it is a radio controlled apparatus. It does not resemble a decoy nor does it deploy or retrieve downed waterfowl.

U.S. Pat. No. 5,903,936 this unit is for attracting waterfowl only, it does not retrieve downed waterfowl or deploy decoys.

U.S. Pat. No. 4,322,908 this unit is remotely driven by a Capstan type torque conversion system it has movement back and forth attracting waterfowl only. It does not retrieve downed waterfowl or deploy decoys.

U.S. Pat. No. 6,601,333**is remote controlled game decoy and game retriever however it does not tow or deploy decoys. It uses a snaring implement for retrieving instead of push rods for retrieving downed waterfowl. It uses tines with hook-end for snaring waterfowl for retrieving downed waterfowl. This unit also uses a jet propulsion system which forces liquid to exit the decoy for movement.

U.S. Pat. No. 5,233,780 this unit is for attracting game only by using calls and movement by radio control, it does not deploy decoys or retrieve downed waterfowl.

Patent No. US 2004/0025770 A1 is similar in some aspects but has been abandoned. It does not have a tandem line for deploying decoy and is the keel is not designed to keep out moss and debris which makes this particular device ineffective.

While the prior art devices may be adequate for their intended purposes, there are some inherent drawbacks with many of the designs incorporated in such prior art devices they are encumber retrieving downed waterfowl or do no work efficiently. Another common problem is the keel is not weighted properly so that the decoy becomes top heavy which causes the motor to not operate properly which becomes problematic when trying to retrieve downed waterfowl.

Dogs generally frighten away waterfowl and other species of game due to their mannerisms. Additionally, the dogs can damage the downed waterfowl with their sharp teeth if they do not retrieve them properly. Another negative is that there are some places that do not allow dogs on state wildlife management or waterfowl management areas.

Boats are also not feasible as they are expensive and are also not allowed in all waterfowl areas. It also may simply not be possible to take a boat to all locations due to road restrictions in getting the boat to a particular location.

### SUMMARY OF THE INVENTION

The Duck Dog offers several options for duck hunters in one complete easy to transport package. The Duck Dog will deploy decoy, act as a decoy, retrieve downed waterfowl and return them to the bank without ever having to wade into the water. Unlike other devices that retrieve downed waterfowl the Duck Dog's unique enclosed propeller system allows it to go into lakes and ponds that are full of moss or debris without ever getting stuck.

This device is light enough for a waterfowl hunter to carry with them unlike other retrieving devices. The Duck Dog uses a remote controlled duck with a pusher on the front end of the duck to push the dead waterfowl back to the bank and deploys decoys without having to get into the water.

The Duck Dog is designed so that said decoy can be selectively controlled in a forward or reverse direction. With the remote control it is easy to steer the decoy to the downed waterfowl, retrieve it and return it to the base in one easy swoop. The keel is properly weighted in the Duck Dog so that it does not become top heavy like so many of the inventions that are in the market place. Nor do any of the models have the design of the fiberglass screen cover around the prop to keep out the moss and debris. The Duck Dog also deploys decoys with a deploying jerk cord assembly.

It is much more cost effective than a hunting dog or buying a boat and due to the unique design as it actually returns the downed waterfowl without much effort or damage to the downed waterfowl. Whereby this decoy deploying waterfowl retrieving device gets rid of the bulky waders, costly boat and repairs, the clean up of dog pins, vet bills, and food for the dog all without getting into the water. Because duck hunting occurs in the cold winter months it is not safe for a hunter to wade into lakes, rivers or ponds as they may contain ice which could be dangerous if the hunter were to trip or fall into the freezing water.

This device fits into a decoy bag and also adds to the decoy spread which adds realism to the decoys. No invention exists that can do all three things the Duck Dog is designed to do such as act as a decoy, deploy decoy and retrieve downed waterfowl all in one easy to carry package.

Everyone that duck-hunts own some form of waterfowl retrieving device; whether it is a dog, boat or by wading in the lakes or ponds. The idea of the Duck Dog is not to use the above but for use of a remote controlled duck that acts as a decoy, that deploys other decoy and has a pusher on the front end of the duck to push the dead waterfowl back to the bank. Whereby this decoy deploying waterfowl retrieving device gets rid of the bulky waders, costly boat and boat repairs, the clean up of dog pins, vet bills, and food for the dog all without getting into the water. This device fits into a decoy bag and also adds to the decoy spread which adds realism to the decoys.

The Duck Dog decoy is different than all the previous similar patented models also due to the fact that it has a fiberglass screened cover around the prop which prevents it from getting stuck in moss or debris. Other models are generally either a decoy or a retrieving unit but do not deploy decoy. There is nothing similar in the marketplace that acts as all three things: a decoy, retriever and deploying device all in one unit. Nor do any of the models have the design of the fiberglass screened cover around the prop.

This decoy deploying waterfowl retrieving device is prop driven versus jet propelled which is another difference. The buoyant decoy duck is level prior to retrieving a downed waterfowl and is weighted down so that it will not topple forward like other devices currently used.

### DETAILED DESCRIPTION OF THE PREFERRED EMBODIMENTS

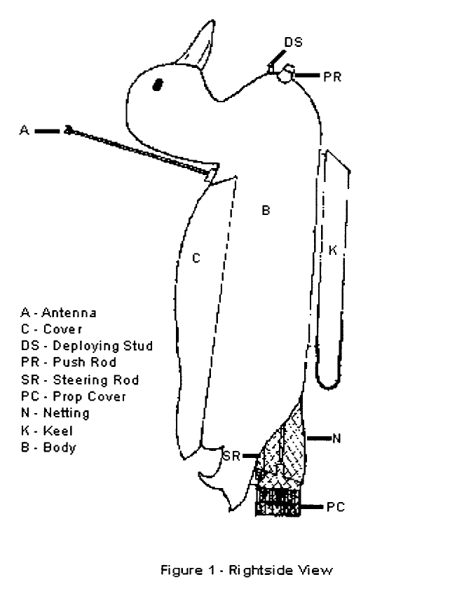

FIG. 1 is a right side view of the decoy deploying waterfowl retrieving device showing my new design;

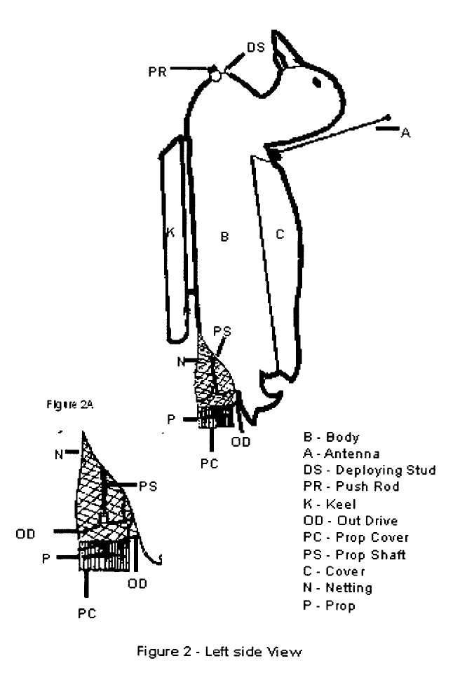

FIG. 2 is a left side view thereof;

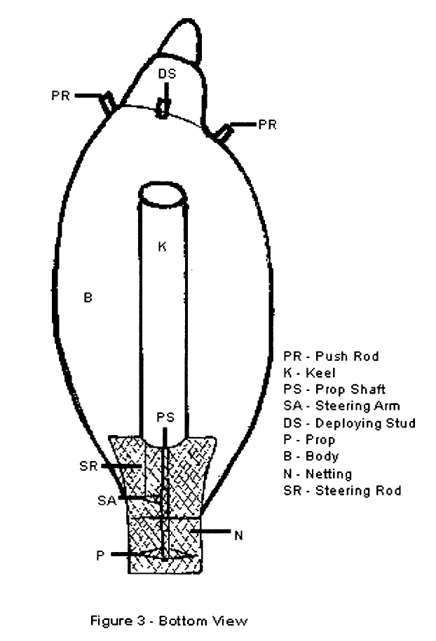

FIG. 3 is a bottom side view thereof;

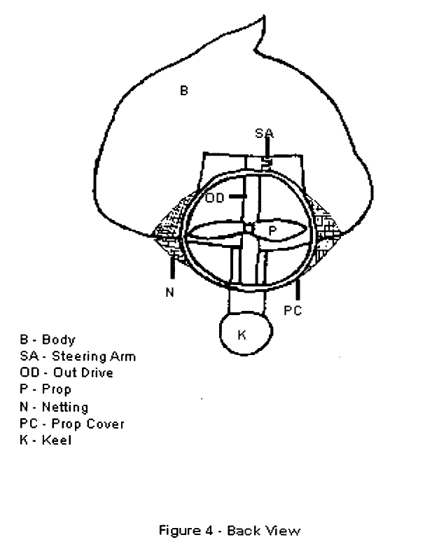

FIG. 4 is a back view thereof;

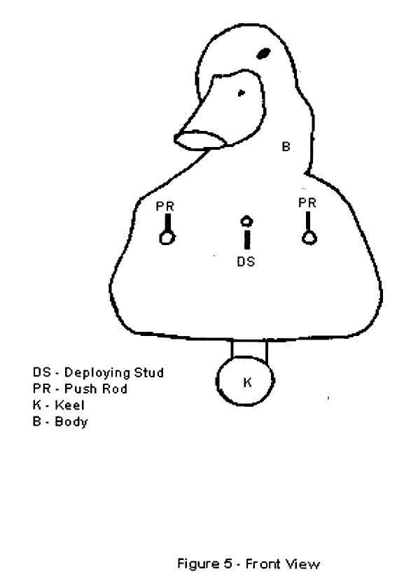

FIG. 5 is a front view thereof;

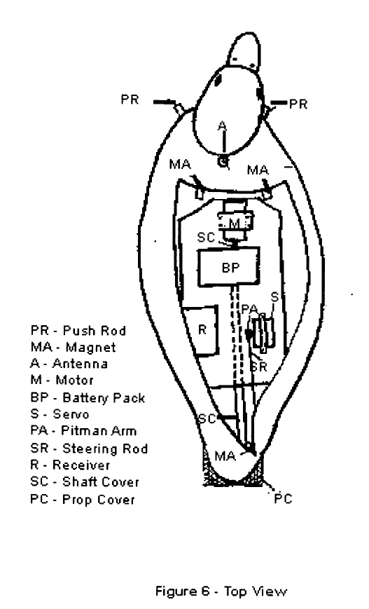

FIG. 6 is a top plan view thereof.

### GLOSSARY FOR THE DRAWINGS

A—Antenna used for receiving a broadcast signal from a transmitter.
C—Cover a removable top portion of the body to gain excess to the motor battery, receiver and servo.
PR—Push Rod a device made to push waterfowl to the bank when in use and retract when being transported.
SR—Steering Rod a rod that hooks to the pitman arm; the other end hooks to the steering arm to give the out drive left and right steering capability.
—Prop Cover a cover to protect the prop when in use and when being transported.
N—Netting that keeps moss and the debris from getting entangled in the prop.
K—Keel to keep the unit stable not letting it turn over. The 45 degree angle at the front is for Maneuvering through light moss and debris.
B—Body to house the units battery, servo, and receiver.
DS—Deploying Stud a stud in the front of the unit for deploying decoys.
P—Prop the prop hooks to the prop shaft to propel the unit by the motor.
OD—Out Drive a device that is used to steer the prop.
PS —Prop Shaft the shaft is affixed to the prop trough the shaft cover to the motor to propel the unit.
M—Magnet three magnets hold the cover on for quick access to the motor, receiver and the battery.
BP—Battery Pack the rechargeable battery pack powers the motor, receiver and servo.
S—Servo the receiver tells the servo how much to steer left or right (it is the steering box).
PA—Pitman Arm the pitman arm is affixed to the servo and a signal is given from the receiver to turn the unit right or left.
R—Receiver when a transmitted signal is sent from the transmitter the receiver sends a signal to the servo to turn the unit and power the motor.
SC—Shaft Cover a tube the pro shaft runs through. This keeps the unit water tight from the prop shaft.
SA—Steering Arm a steering arm hooks to the out drive, the steering rod hooks to it and to the Pitman arm.

### GLOSSARY

Deploy—to distribute systematically or strategically. The act of deploying; a spreading out.
Downed Waterfowl—Ducks that are made to fall or to bring down and that are no longer alive or that are dead.
Jerk Cord Assembly—A retractable cord reel assembly made to deploy duck decoys.
Tandem—One after another.
Waders—Waterproof hip boots (sometimes extending to the chest) worn by anglers.

I claim:

1. A decoy deploying waterfowl retrieving device that serves as a decoy in the water to attract the waterfowl, retrieve the downed waterfowl and deploy decoys to attract waterfowl.

2. The device of claim 1 wherein a removable lid exposes the motor, receiver, steering servo and battery pack.

3. The device of claim 2 wherein a removable lid contains plural magnets underneath the lid and on the base securing it to the decoy.

4. The device of claim 2 wherein a predetermined rechargeable battery pack substantially 7.2 volts NI-MH and a predetermined 380 electric motor is contained. It is approximately 17″ long, 6″ wide.

5. The device of claim 1 wherein a fiberglass screen protects the prop on the back of the decoy to keep the moss and weeds from being entangled in the prop.

6. The device of claim 1 wherein a keel underneath the decoy allows the decoy to stay upright.

7. The device of claim 6 wherein the front of the keel has about a 45 degree angle to break the flow of water to help maneuver through light moss or weeds.

8. The device of claim 6 wherein the back of the keel is weighted for ballast to make it level when retrieving ducks or deploying decoys.

9. The device is remote steered to deploy a decoy spread and to push downed waterfowl back to the bank.

10. The device of claim 9 wherein there is a hand held approximately 2-channel pistol-grip transmitter that transmits a signal to a receiver to steer the decoy left and right or with forward and backward motion.

11. The device of claim 9 wherein there are plural extendable pushrods that are manually pulled out prior to use.

12. The device of claim 11 wherein the pushrods are retractable so the pushrods will not break or bend when they are stored or transported.

13. The device of claim 9 is stud embedded on the front of the decoy that pulls a tandem line of decoys and drops the weight depending on where you want your spreads deployed.

14. The device of claim 9 wherein there is a deploying jerk cord assembly to pull the multiple decoy back to shore.

15. The device of claim 14 wherein the cord is made of nylon with several swivels for hooking up multiple decoys. This feature also adds motion to the decoy spread for more realism.
